(19) United States
(12) Patent Application Publication
(10) Pub. No.: US 2008/0318766 A1
(43) Pub. Date: Dec. 25, 2008

(54) Novel nanocatalyst for edible oil hydrogenation

(75) Inventors: Syed Tjammul Hussain, Islamabad (PK); Mohammed Mazhar, Islamabad (PK); Muhammad Hasib-ur-Rehman, Islamabad (PK)

Correspondence Address: SARFARAZ K. NIAZI, 20 RIVERSIDE DRIVE, DEERFIELD, IL, 60015, US

(73) Assignee: Quaid-e-Azam University, Islamabad (PK)

(21) Appl. No.: 11/766,244

(22) Filed: Jun. 21, 2007

(51) Int. Cl. B01J 31/00

(52) U.S. Cl. 502/103

(57) ABSTRACT

The present invention reports a lanthanum-doped nickel/alumina catalyst for the hydrogenation of oils resulting in very low saturated fats, high polyunsaturated fats requiring specific particle size, surface area and porosity of the catalyst; the invented catalyst produces less pressure drop during processing and provides an easily filterable system resulting in a economically practical solution to hydrogenate oils for use by humans and animals.

### FIELD OF INVENTION

The present invention relates to a nickel on alumina catalyst which has been promoted with lanthanum for use in food industries for hydrogenation of edible oils. This new catalyst substantially reduces saturated fats in the hydrogenated food products.

The edible oil catalysts based on alumina, silica, diatomaceous earth, zeolites, promoted with copper, sulfur are employed for the selective hydrogenation. The triglycerides, often containing polyunsaturated fatty acids, are often hydrogenated prior to use, so as to increase stability and adjust melting point.

For example, processed soybean oil is susceptible to oxidation resulting in deterioration of its organoleptic properties upon storage even at ambient temperature. When the oil is to be used at higher temperature, for example, as frying oil, the adverse organoleptic consequences of oxidation becomes even more pronounced.

The commonly accepted origin of oxidative deterioration is the presence of highly unsaturated components, such as the triene moiety, linolenate, in soybean oil. Partial hydrogenation improves stability of the resulting product, thereby extending the shelf-life and permitting use of oil at higher temperatures.

The fats and oils which are the subject of this invention, hereinafter collectively referred to as fatty materials, are triglycerides of fatty acids, some of which are unsaturated and some of which are saturated. In vegetable oils, the major saturated fatty acids are lauric (12:0), myristic (14:0), palmitic (16:0), stearic (18:00), arachidic (20:0). The notation, “18:0”, for example, means an unbranched fatty acid containing 18 carbon atoms and 0 double bonds. The major unsaturated fatty acid of vegetable oils maybe classified as monounsaturated, chief of which are oleic (18:1) and polyunsaturated, chief of which are thediene, linoleic acid (18:2) and the triene, linolenic acid (18:3). Unbranched vegetable fats and oils contain virtually exclusively cis-unsaturated acids.

During hydrogenation of polyunsaturated oils, side reactions occur, such as geometric and positional isomerization. The extent to which geometric isomerization occurs has a strong influence on the melting behaviors of the hydrogenated oil. The double bonds of naturally occurring triglycerides oils are exclusively present is in the cis-form. The geometric isomerization occurring simultaneously with the partial hydrogenation leads to the formation of trans-isomers. The melting point of cis and trans isomers are clearly different. For glycerol trioleate, the melting points are 5 and 42° C., respectively. Additionally, for instance, elaidic acid (the trans-isomer) has a melting point of 46.5° C., while oleic acid (the cis-isomer) has a melting point of 13.4° C. (alpha form) or 16.3° C. (beta form).

Accordingly, the eventual melting behavior of triglycerides is partly determined by the triglycerides composition and the trans-isomer content obtained after hydrogenation.

To obtain a melting range as steep as possible and a good melting point, a maximum trans isomer content is desirable. Furthermore, a minimum formation of completely saturated compounds is desirable because they have a melting point that is higher than that of partially hydrogenated triglycerides.

In a selective hydrogenation it is accordingly attempted to achieve a maximum conversion of polyunsaturated triglycerides to monounsaturated triglycerides having a maximum trans-isomer content i.e., the ultimate goal is the reduction of triene to diene without attendant trans acid formation or saturate formation. In practices it is observed that partial reduction results in lowering both triene and diene and increasing the monoene, saturate, and trans levels.

The extent to which geometric isomerization occurs depends, among other factors, on the reaction conditions employed. Reduction of the hydrogen concentration on the catalyst surface promotes the formation of trans-isomers. This reduction can, for instance, be obtained by using a high reaction temperature and a low hydrogen pressure. The choice of the type of the type of the catalyst can also influence the extent of formation of certain isomers.

Ideally one desires this hydrogenation to be highly specific, reducing only triene to diene, linoleate, without effecting cis to trans isomerization. In practice, this goal is very difficult to achieve. The present invention of a novel catalyst provides one solution to achieve this goal.

One index of selectivity for the hydrogenation reaction used herein is the Solid Fat Index (SFI). Another index of selectivity relied upon here and commonly used elsewhere can be better understood from the following partial reaction sequence, where k is the rate constant for the indicated hydrogenation step.

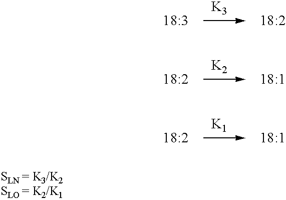

S_{LN} is termed the linolenate selectivity; a high value is characterized by relatively high yields of dienoic acid in the reduction of unsaturated triglycerides containing trienoic acid. S_{LO} is the linoleate selectivity; a high value is characterized by relatively high yields of monoenoic acid in a reduction of an unsaturated triglyceride containing dienoic acids. Oil such as soybean oil contains both of these acids.

The ultimate goal in the hydrogenation reaction is the reduction of triene to diene without attendant trans-acid formation or saturate formation. In practice it is observed that partial reduction results in lowering both triene and dience and increasing the monoene, saturate and trans levels.

In summary the hydrogenation should accomplish the following:
1) To reduce the content of unstable polyenic compounds of the oil.
2) To limit the formation of saturated compounds during the hydrogenation, since these saturated compounds increase the higher melting point.
3) To limit the formation of unstable conjugated dienic compounds.4)

The present invention permits production of less hydrogenated product having an iodine value (IV) of not substantially above 100 and typically in the range of 60-100 with a 60-70 IV range being preferred, when the shortening like consistency is desired. Another object of the present invention is to provide a catalyst and the method for making the catalyst having improved catalytically properties and healthier product (in terms of the lower percentage of saturated fats and higher percentage of polyunsaturs).

It is further object of this invention to provide a catalyst which does not produce a high pressure drop in the system where it is used.

The present invention provides an improved hydrogenation catalyst for use in hydrogenation reaction, said catalyst being comprised of a nickel metal on alumina ceramic support doped with lanthanum.

Other embodiment of the invention is provided by the use of this catalyst providing better filtration of the final product.

A further object is to provide a supported metal catalyst which can be prepared economically and which has high activity per weight of active material.

### BACKGROUND ART

Agricultural feedstock, such as soybean, palm, corn, canola, peanut and sunflower oils, are often hydrogenated or partially hydrogenated during the production of edible fats and oils. This is done to impart desirable characteristics such as a harder consistency, a higher melting point, and better oxidation stability which improve a product's resistance to spoilage or rancidity. Such hydrogenated oils end up as margarines, shortenings and frying oils, and as ingredients in finished products such as mayonnaise, chocolate and ice cream.

Nickel-based catalytic technologies are currently widely used for the slurry-phase hydrogenation of edible fats and oils. However, during hydrogenation, an unwanted reaction also occurs in which the naturally occurring cis isomers of the triglyceride molecule in unsaturated fats are partially converted into unwanted trans isomers. Under typical hydrogenation, operating conditions (130-200° C., 0.5-4 bar); a relatively high amount of trans isomers (up to 45% w/w) may be formed.

Recent studies indicate that trans isomers in edible oils may have adverse health effects. For instance, they have been shown to raise cholesterol levels in humans, in much the same way as saturated fats do. As a result, the US Food and Drug Administration has established new regulations as part of its nutritional Labeling Act that has required food manufacturers to state the trans fat content of their products on the labels of food packages beginning 1 Jan. 2006.

As consumer demands continue to call for more healthful foods, food processors are seeking ways to reduce the level of trans fatty acids (TFAs)—whose negative health effects have recently been identified—in processed and baked foods. To respond to these market pressures, makers of edible oils are seeking cost-effective ways to reduce TFA levels in their products without imposing unwanted consequences, such as increasing the product's overall saturated fat content, or decreasing its shelf life.

TFA levels in edible oils can be lowered in different ways. Inter-esterification is an example of a process that is commercially available to obtain lower trans isomer levels in edible oils. In this process, the fatty acid chains of two different oils (a fully hydrogenated fat and liquid oil) are redistributed in such a way that an oil mixture is produced with desired properties and a negligible amount of trans isomers. However, while inter-esterification produces the desired end result, many believe that this approach will not be the final solution for global manufacturing of edible oils with low levels of TFA, especially in the US, due to its relatively high cost and/or the limited availability of the desired liquid oils.

Meanwhile, several novel hydrogenation reactor configurations are also under development to minimize TFA levels in edible oils. In one such design, the hydrogen concentration at the catalyst surface is modified by carrying out the hydrogenation at extremely low pressures, under so-called ‘supercritical conditions’, in order to optimize catalyst activity and selectivity.

Another approach that is under development to reduce TFA levels in partially hydrogenated vegetable oils is the use of electrochemical hydrogenation. Also, in modifying the conventional approach, the trans selectivity of conventional nickel-based hydrogenation catalysts can be improved by changing the hydrogenation reaction conditions, such as temperature and hydrogen pressure. Reaction condition changes that lead to higher hydrogen concentration at the surface of the catalyst will result in reduced TFA levels, such as lowering the temperature, increasing the hydrogen pressure, increasing the stirrer speed, and lowering the catalyst loading.

However, despite a decrease in the amount of trans isomers, the end result is insufficient due to existing commercial equipment limitations. For instance, to achieve a TFA level below 10% (w/w) in the hydrogenated oil. which is generally the goal, extremely high hydrogen pressures (above 50-60 bar) would be required, while existing equipment at edible oil hydrogenation plants can mostly handle up to 5 bar. Also, a major consequence of applying such high pressures is the undesired formation of saturates, which would lead to a change in composition and production of oil with too much solid fat in it. Meanwhile, as most producers of edible oils have current equipment limitations, in terms of maximum operating pressures, such extreme reaction condition modifications are not likely to be an affordable or practical solution to meet the demand for lower-TFA products. There is a worldwide search for catalyst systems that would enable the production of partially hydrogenated edible oils with the desired low amount of TFAs (<10% w/w) and without the subsequent elevation of solid fat levels in the oil mixture. Efforts are underway to produce an affordable catalytic technology with high activity and trans selectivity that could be used as a drop-in substitute in existing hydrogenation reactors. Generally, the data show that the conventional nickel-based catalysts may produce a low amount of saturated fats, but the accompanying amount of trans isomers that are formed remains too high. Palladium-based catalysts show similar results to the nickel-based ones. However, the platinum-based catalysts demonstrate more favorable results in terms of reducing the formation of trans isomers but also produce relatively high levels of saturated fats. Additionally, the cost of platinum-based catalysts is likely to make them a less useful choice for large-scale hydrogenation of oils and fats. As a result, the general consensus in the literature is that nickel-based, cheaper sources of catalysts are of a lesser value in reducing the trans fats. The present invention is therefore contrary to the popular teaching.

Supported metal catalysts are known and their use in numerous reactions, including the hydrogenation of edible oil, has been described in the literature. These supported metal catalysts are often utilized for the hydrogenation of edible oils to increase the saturation content from low saturation content to very high saturation content. Products produced from these hydrogenated edible oil includes, for example, salad oil, margarines, shortening, candles and confections.

The term supported metal catalysts can be defined as a catalyst, whereby an active metal precursor (nickel, palladium, copper, cobalt, etc.) is deposited on an oxide support by means of precipitation, decomposition, or impregnation. One preferred supported metal catalyst is a nickel hydrogenation catalyst. References describing nickel-supported and their uses include U.S. Pat. Nos. 5,463,096 and 5,285,346 and PCT application number WO 94/06557. U.S. Pat. No. 5,463,096 describes a process for the preparation of supported nickel catalysts which are used particularly for the hydrogenation of fatty acids and vegetable oil which are contaminated with sulfur compounds at a level less than about 10 parts per million, PCT application number WO 94/06557 describes the preparation of supported nickel catalysts to which promotion metal (particularly zinc) are added during the precipitation stage of catalyst formation. Both of these references disclose a traditional approach to edible oil hydrogenation catalyst improvement, i.e., catalyst performance is improved by altering the structure of the catalytic precursor oxides. The support medium serves only to hold the reduced, activated metal.

### SUMMARY OF THE PRESENT INVENTION

The present invention provides novel nickel/lanthanum-alumina catalysts which have surprisingly considerably improved activity aid which have an atomic ratio of nickel/lanthanum-alumina of between 20 and 1, the active metal surface area is between 100-500 m²g⁻¹. The average pore size, depending upon the above atomic ratios is between 4-10 nanometers. Preferably tire atomic ratio of nickel to alumina of this catalyst is between 12 and 3, most preferably between 12 and 8 because this result is higher hydrogenation selectivity of the catalyst i.e. less formation of completely saturated triglycerides which is probably due to higher average mesopore size.

Furthermore, this catalyst preferably has an open porous structure with macropores of 50-100 nanometers, depending on the nickel/alumina ratio, and mesopores having an average size between 8-12 nanometers. As demonstrated in the SEM analysis, the macropores are formed by interconnected catalysts platelets.

This catalyst has an active nickel surface dispersion of 45% (as measured by chemisorption). The BET total surface area is between 90-150 m²g⁻¹ of catalyst. The average diameter of the nickel crystallites is preferably between 5-10 micrometers.

The above mentioned improved catalyst can be advantageously prepared by the process in which an insoluble nickel compounds is precipitated from an aqueous solution of nickel salt with an excess alkaline precipitation agent, the precipitate is subsequently allowed to age in suspended form and then is collected, dried, reduced and dispersed in a suitable ceramic supports include alumina, silica, zeolite, lanthanum-stabilized alumina, diatomaceous earth, titanium oxide and mixture thereof.

After precipitation and aging according to the present, invention, the precipitate is separated from the liquid, washed, dried, activated and then dispersed in oil to prevent oxidation, this by known procedures.

Nickel compounds which can be used as starting material for the catalyst according to the invention are water soluble nickel compounds such as nitrates, sulfates, acetate, chloride and formate. The solutions which are charged to the precipitation reactors preferably contains 10 and 80 g of nickel per liter, especially preferred are solutions which contain between 25 and 60 g of nickel per liter.

Alkaline precipitation agents which can be used as starting material for catalyst according to the present invention are alkali metal hydroxide, alkali metal carbonate, the corresponding ammonium compounds and mixtures of the above mentioned compounds. The concentration of alkaline solution which is fed into the precipitation reactor is preferably between 20-300 g alkaline material (calculated as anhydrous material) per liter (in as far as the solubility allows this), more particularly between 50-250 g per liter.

The nickel salt solution and the alkaline solution are added in such amounts per unit of time that an excess of alkaline compound is present during the precipitation step, so that the pH of the liquid is between the ranges of 8-9, preferably within the range of 10.5-11.0. Sometimes it is necessary to add some more alkaline solution during the aging step in order to keep the normality or pH within the range as indicated above.

The temperature at which the precipitates take place can be controlled by adjusting the temperature of the liquids fed in. The required vigorous agitation of the liquid in the precipitation reactor preferably takes place with mechanical energy input of between 5 and 2000 watt per kg of solution. More preferably the agitation takes place with a mechanical energy input of 100 to 2000 watts/kg of solution.

Usually the pH of the liquid during the aging reaction is controlled evaporation of alkali salt and containing the evaporated volume by the addition of water, so that the total reactor volume is always kept the same. The total aging time in the reactor being maintained at 240-300 minutes and the temperature kept constant at 95-99° C. during the reaction. The green filter cake thus obtained is washed and dried at 120° C. for 48 hours. Thereafter the dried catalyst is reduced in hydrogen at 360° C. for 4 hours and then dispersed in oil to prevent the catalyst oxidation.

The filterability of the green cake was determined as follows:

One liter of green cake aqueous suspension with 4% (w/w) solids from the reactor was filtered over a Buchner funnel with a Scheieher and Still filter (Whatman) black band filter with a diameter of 125 mm. The vacuum applied was 3,000-4,000 pascals, and obtained with an aspirator. The time of filtration in minutes necessary for filtering 4 liters of distilled water over the bed of green cake obtained was taken as a yardstick for the filterability of the green cake. The time was around 3 minutes.

### EXAMPLE-1

The lanthanum doped alumina employed was a gamma alumina doped with 1.7% lanthanum having a surface area of about 150 m²g⁻¹ and a pore volume of about 0.42 mg/g and having a surface weighted mean diameter D[5,3] of 5 μm. The average pore diameter was thus about 16 nm. A stock solution was prepared by dissolving 75 Gms of Ni(NO₃)₂.6H₂O in 0.563 L of deionixed water. 12 ml of HNO₃ and 0.341 L of 28% aqueous ammonia was added to the solution at room temperature and the slurry was digested for 30 minutes before adding 48 Gms of alumina in which 1.5-4.0% of lanthanum was embodied in the lattice of alumina. The slurry was heated to 90-95° C. under vigorous agitation. The pH of the solution was 10.0. The digestion of the slurry was completed in 4.0 hours and the pH was dropped to 6.5. The green cake was washed, dried at 120° C. for 48 hours and then reduced at 360° C. for four hours and then dispersed in oil. The reduced catalyst had a total nickel content of 23% and a nickel surface area of 38 per g of total nickel. The x-ray diffraction data revealed the presence of highly dispersed nickel on the surface. The profile of the moles of hydrogen consumed during the reaction compared with the profile of similar consumption from commercial catalysts showed remarkable difference.

### EXAMPLE-2

The catalyst was made in accordance with the procedure defined in the example-1 above except the alumina used was Alcoa company's activated grade CP-100 with surface area equal to 450 m²g⁻¹.

### EXAMPLE-3

The catalyst was made in accordance with the procedure defined in the example-1 except the alumina was Alcoa company's activated grade CP-100 with surface area equal to 145 m²g⁻¹.

### EXAMPLE-4

The catalyst was made in accordance with the procedure defined in the example-1 except the alumina was Alcoa's grade MI-2005 with surface area equal to 345 m²g⁻¹.

### COMPARATIVE EXAMPLE

The comparative reference sample comprised of 25% nickel and 75% diatomaceous earth (commercial product of Engelhard). This composition is the most widely used product for the hydrogenation of oils in the world.

Catalyst Testing

To test the efficacy and activity of the catalysts, two liters of soybean oil was hydrogenated at 160° C. with 0.02% (w/w) of catalyst. The experimental lay out is presented in FIG. 1.

FIG. 1

The hydrogen pressure was kept at 45 PSI. The samples were taken after every 20 and 40 minutes and analyzed for RI (Refractive index), IV (iodine value) and SFI (Solid fat index). The results are presented in Table-1.

TABLE 1

| | | | SFI: C- | SFI: C- | SFI: C- | SFI: C- |
|---|---|---|---|---|---|---|
| | IV | RI | 18:0 | 18:1 | 18:2 | 18:3 |
| Catalyst | 20/40 mins | 20/40 mins | 20/40 mins | 20/40 mins | 20/40 mins | 20/40 mins |
| Example-1 | 104.7 | 1.4649 | 5.6 | 40.9 | 34.9 | 3.3 |
| | 91.7 | 1.4628 | 17.6 | 55.4 | 22.7 | 1.7 |
| Example-2 | 89.7 | 1.4627 | 6.5 | 57.7 | 21.8 | 0.7 |
| | 59.9 | 1.4593 | 22.2 | 60.5 | 4.4 | 9.0 |
| Example-3 | 100.2 | 1.4638 | 7.5 | 46.7 | 31.1 | 2.3 |
| | 72.9 | 1.4608 | 47.6 | 57.6 | 12.9 | 0.3 |
| Example-4 | 118.6 | 1.466 | 4.8 | 33.7 | 44.6 | 4.6 |
| | 61.0 | 1.4651 | 5.3 | 39.9 | 39.0 | 3.5 |
| Comparative | 102.2 | 1.4640 | 5.6 | 48.1 | 31.9 | 2.0 |
| Example | 70.4 | 1.4605 | 12.2 | 69.7 | 5.6 | 0.1 |

Result Analysis

The above examples show the effect of various surface areas, pore sizes and the inclusion of lanthanum on the efficacy of conversion of oils to saturated forms. It is noteworthy that whereas examples 1-4 contained lanthanum arid were compared to the comparative example that did not contain lanthanum, the application of lanthanum becomes obvious when a specific pore size and surface area is combined with lanthanum. As a result Example-4 offers the best mode of the catalyst invented here. Fact that it was not possible to predict whether lanthanum would have any effect unless a proper pore size and surface area are present, makes this invention surprising and innovative. The first parameter of importance in this invention is the level of trans isomer, which is dependent directly on the proportion of the C-18:0 proportion. The best mode example-4 shows that both at 20 and 40 minutes, this mode yields the lowest percentage obtained. As a result, the present invention assures that the lowest quantity of trans isomer is formed in the process. The next parameter of importance is the proportion of polyunsaturated forms which were higher when the best mode invention was used.

### DESCRIPTION OF DRAWING

FIG. 1: Flowchart for the testing of catalysts

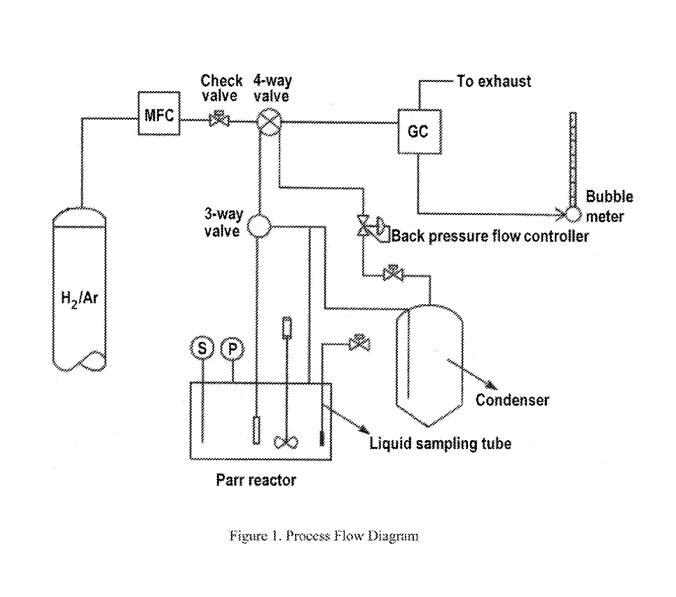

We claim:

1. A nickel/alumina catalyst doped with lanthanum, in which the atomic ratio of nickel/alumina is between 20 and 5 and active nick surface area is between 70 and 150 m²g⁻¹ nickel, this catalyst has an open, porous structure wherein the macropore size is between 50-100 nanometers and the mesopore size is between 8 and 20 nanometers.

2. A catalyst according to claim 1, in which the active nickel surface area is between 35 and 50 m²g⁻¹ nickel.

3. A catalyst according to claim 1, in which the BET (Brunauer, Emmett and Teller) Langmuir adsorption total surface area is between 80 and 450 m²g⁻¹.

4. A catalyst according to claim 1, in which the nickel crystallites have an average diameter between 5 and 10 nanometers.

5. A catalyst according to claim 1, in which the macropores are formed by interconnected catalyst platelets.

6. A catalyst according to claim 1, which is combined with a support material comprising of alumina, silica, zeolite, diatomaceous earth, magnesium oxide, barium carbonate and a combination thereof of these support materials.

7. Process for the catalytic hydrogenation of unsaturated fatty compounds, characterized in that a catalyst according to claim 1 is used.

8. A product prepared by claim 1 and having an iodine value between 65-70 and a solid fat content at 30° C. below 3.5 preferably blow 2.5%.
